(19) United States
(12) Patent Application Publication
(10) Pub. No.: US 2024/0299852 A1
(43) Pub. Date: Sep. 12, 2024

(54) ENABLING A USER TO PLAY A MULTIPLAYER VIDEOGAME VIA A SINGLE-CLICK SELECTION OF A LINK PRESENTED IN A SOCIAL MEDIA PLATFORM

(71) Applicant: ARTIE, INC., West Hollywood, CA (US)

(72) Inventor: Armando McIntyre-Kirwin, Los Angeles, CA (US)

(21) Appl. No.: 18/182,239

(22) Filed: Mar. 10, 2023

(51) Int. Cl. A63F 13/61; A63F 13/87

(52) U.S. Cl. CPC A63F 13/61; A63F 13/87

(57) ABSTRACT

The system creates a posting on a social media platform by a social media identity associated with a videogame, where the posting includes a link to the videogame. The system receives a single-click selection of the link, where the single-click selection is received through the social media platform. Upon receiving the single-click selection of the link, the system launches the videogame in an embedded browser running within the social media platform, where a user remains within the social media platform while interacting with the embedded browser. The system enables the user to play the videogame through the embedded browser without downloading an executable to a user device associated with the user.

### BACKGROUND

An app store is a digital distribution service operated by various platforms, such as Google and Apple, that allows users to browse and download software applications such as videogames. To download the game, the user needs to enter the app store and find, download, and install the game. The whole process involves several steps. The installation of the game can take several minutes to complete. Once the game is downloaded, users can play the game, however, the app store acts as a middleman constraining and, in some cases, modifying the interaction between the user and the videogame provider.

### SUMMARY

Disclosed here is a system and method to enable a user to play a videogame via a single-click selection of a link presented in a social media platform. The videogame can be a multiplayer videogame and can enable user A from social media platform A and user B from social media platform B to play the videogame together. The system creates a posting A on the social media platform A by a social media identity A associated with the multiplayer videogame, where the posting A includes a link A to the multiplayer videogame. The system also creates a posting B on the social media platform B by a social media identity B associated with the multiplayer videogame, where the posting B includes a link B to the multiplayer videogame.

The system receives a single-click selection of the link A and a single-click selection of the link B, where the single-click selection of the link A is received through the social media platform A and the single-click selection of the link B is received through the social media platform B. Upon receiving the single-click selection of the link A, the system launches a multiplayer videogame in an embedded browser A running within the social media platform A, where the user A making the single-click selection of the link A remains within the social media platform A while interacting with the embedded browser A. Similarly, upon receiving the single-click selection of the link B, the system can launch a multiplayer videogame in an embedded browser B running within the social media platform B, where a user B making the single-click selection of the link B remains within the social media platform B while interacting with the embedded browser B.

The system enables the user A and the user B to play the multiplayer videogame together through the embedded browsers A and B without downloading an executable to a user A device associated with the user A and a user B device associated with the user B.

### BRIEF DESCRIPTION OF THE DRAWINGS

Detailed descriptions of implementations of the present invention will be described and explained through the use of the accompanying drawings.

FIG. 1 shows a traditional system for playing a game on a mobile device.

FIG. 2 shows a traditional system for playing a game from an app store.

FIG. 3 shows a system enabling the user device to directly interact with a server providing the game.

FIG. 4 shows how a link to the game can be presented to the user.

FIG. 5 shows a frame from the game.

FIG. 6 is a flowchart of a method to enable a user to play a videogame via a single-click selection of a link presented in a social media platform.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here is a system and method to enable a user to play a videogame via a single-click selection of a link presented in a social media platform. The videogame can be a multiplayer videogame and can enable user A from social media platform A and user B from social media platform B to play the videogame together. The system creates a posting A on the social media platform A by a social media identity A associated with the multiplayer videogame, where the posting A includes a link A to the multiplayer videogame. The system also creates a posting B on the social media platform B by a social media identity B associated with the multiplayer videogame, where the posting B includes the link A to the multiplayer videogame.

The system receives a single-click selection of the link A and a single-click selection of the link B, where the single-click selection of the link A is received through the social media platform A and the single-click selection of the link B is received through the social media platform B. Upon receiving the single-click selection of the link A, the system launches a multiplayer videogame in an embedded browser A running within the social media platform A, where the user A making the single-click selection of the link A remains within the social media platform A while interacting with the embedded browser A. Similarly, upon receiving the single-click selection of the link B, the system can launch a multiplayer videogame in an embedded browser B running within the social media platform B, where a user B making the single-click selection of the link B remains within the social media platform B while interacting with the embedded browser B. User B can also be an artificial intelligence (AI) in lieu of a human player.

The system enables the user A and the user B to play the multiplayer videogame together through the embedded browsers A and B without downloading an executable to a user A device associated with the user A and a user B device associated with the user B.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Enabling a User to Play a Multiplayer Videogame via a Single-Click Selection of a Link Presented in a Social Media Platform

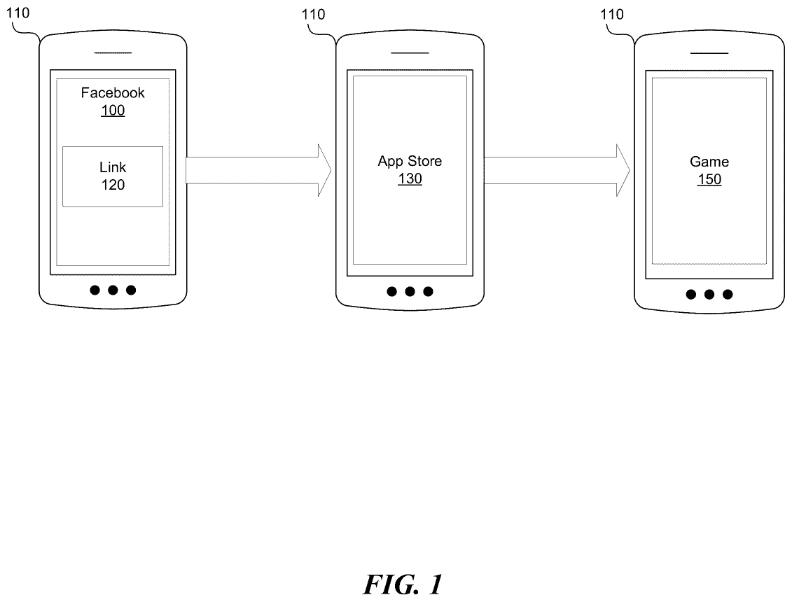

FIG. 1 shows a traditional system for playing a game on a mobile device. Traditionally, a user can visit a social media platform 100 on a user device 110, such as a mobile device, a smart watch, a tablet, a personal digital assistant, a desktop computer, etc. The social media platform 100 can present an advertisement or a link 120 to a game. If the user wishes to play the game, the user can select the link 120. Upon selecting the link 120, the user device 110 presents an app store 130, such as a Google or Apple app store, to the user. The app store 130 is a separate software application (“application”) from the social media platform 100, and interactions between the app store 130 and the user are not communicated with the social media platform 100.

Once the user device 110 presents the app store 130, the user needs to download the application for the videogame (“game”) 150. Once the game 150 is downloaded on the user device 110, the user can play the game. This process involves a significant overhead for the user because the process involves 3 steps, and a noticeable amount of time (approximately 5 minutes), to select the game, go to the app store, and install the game on the user device 110. By contrast, the disclosed technology requires a single-click selection of the link representing the game, and instant playing of the game, without the need to download the application for the game 150 to the user device 110, as described below.

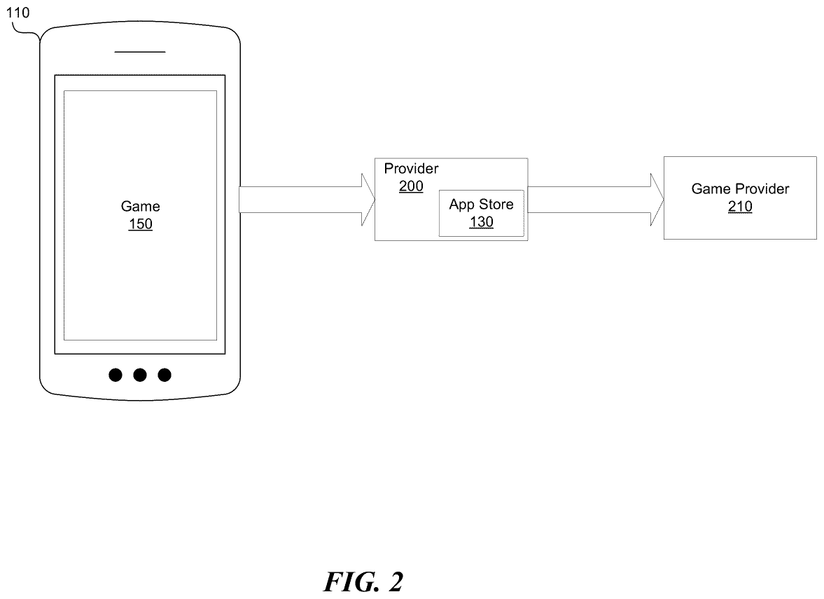

FIG. 2 shows a traditional system for playing a game from an app store. Once the user device 110 downloads the game 150 from the app store 130, the user executes at least part of the game 150 on the user device 110. The quality of the game in this scenario is at least partially limited by the technical capabilities of the user device 110. In addition, the user actions are first processed by the provider 200 of the app store 130. For example, if the app store 130 is provided by Google, the provider 200 is Google, or if the app store 130 is provided by Apple, the provider 200 of the app store 130 is Apple. The app store 130 gathers the user interactions with the game 150, processes them, and sends them to the game provider 210.

The app store 130 in the processing step can limit which interactions reach the game provider 210, and even for the interactions that do reach the game provider 210, the app store 130 can modify the interactions. For example, the app store 130 can modify payments made in the game 150. Specifically, if the user purchases an item in the game 150, the app store 130 can take 30% off the price of the item, and send 70% of the funds to the game provider 210. In addition, the app store 130 can prevent the game provider 210 from receiving certain user data, such as the time of day when the game is played, the amount of time that the user plays the game, user demographics, etc.

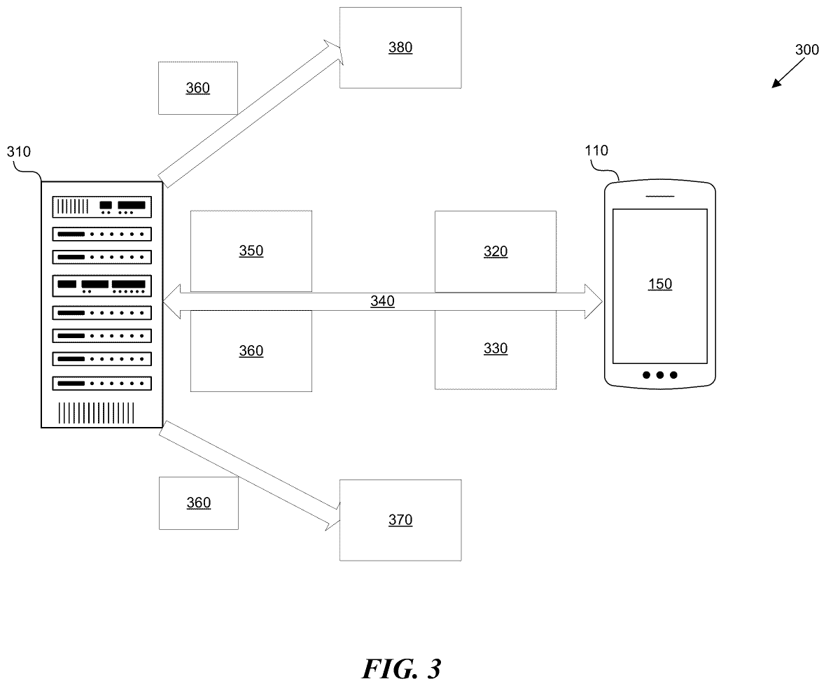

FIG. 3 shows a system 300 enabling the user device 110 to directly interact with a server 310 providing the game. In the system 300, the user device 110 can interact directly with the server 310 without the interference of the provider 200 in FIG. 2. The user device 110 sends all the user interactions 320 to the server 310. Consequently, the server 310 receives all the payments that the user makes in the game, and gathers user data 330 such as an amount of time the user plays the game, user demographics, time of day when the user plays the game, etc.

In the system 300, the game 150 mostly executes on the server 310, which has higher computational resources than the user device 110. Consequently, the appearance of the game and the functions of the game can be more sophisticated than in the traditional system where the game was at least partially executing on the user device 110. In the system 300, the limiting factor on the quality of the graphics delivered to the user device 110 can be the network bandwidth 340 and/or the computational resources of the user device 110.

To increase the quality of the graphics delivered to the user device 110, the server can determine the assets 350 that need to be delivered to the user device 110, such as static images, animated images, animations, software, etc. The server 310 can determine the chronological order of the assets 350. In other words, the server can determine at what time the user device 110 will need a particular asset among the assets 350, and can deliver the assets 350 in the chronological order.

Additionally, the server 310 can adjust the quality of the assets 350, such as images and animations delivered to the user device 110, based on the network bandwidth 340 and/or the computational resources of the user device 110. For example, if the network bandwidth 340 is low, the server can provide lower-resolution static and animated images and/or animations to the user device 110.

Because the server 310 is directly interacting with the user device 110, without constraints imposed by the provider 200 in FIG. 2, the server 310 and the user device 110 can communicate new data structures 360 with each other. The new data structure 360 can be a non-fungible token (NFT). The NFT 360 can represent an asset such as a character, an object, a reward, or a purchase that the user made in the game 150. The NFT 360 can be dynamic and can change. For example, the NFT 360 can represent the user's character, and as the user progresses through the game 150, the character can gain additional armor, skills, or the character can change the appearance, etc. The NFT 360 can update based on the character changes in the game. In addition, the server 310 can distribute the NFT 360 to the various platforms 370, 380 that can interact with the NFT. Consequently, the platforms 370, 380 can receive the updates to the NFT 360.

For example, the other platforms 370, 380 can include social media platforms, gaming platforms, NFT marketplaces, etc. If the character adds an ax to his armor, the other platforms 370, 380 can update the appearance of the character to include the ax.

In addition, the system 300 can optimize the assets 350 delivered to the user device 110 based on the type of the user device 110. When the user device 110 is a mobile device, which inherently has less computing power than a personal computer, the system 300 can adjust a multitude of factors that increase or decrease performance of the code delivered to the user device 110, including the data size of digital assets, resolution of graphics, fidelity of digital assets such as audio files or image files, number of polygons, framerates, and more.

The system 300 can provide a distributed login/user account management system that sits behind each instance of multiple games 150. For example, the game 150 can track the user's login, state e.g. user's progress across multiple sessions of the same game and across multiple games, and payment processing features. Effectively, any user interacting with any game 150 in the network of games offered by the system 300 essentially “joins” the platform and thus has a unified user account across any of the existing games 150, and games that other people make on the platform in the future.

The system 300 improves the concept of a traditional in-game leaderboard by making the leaderboard accumulate players from across the social media platforms into one “meta-leaderboard” that exists across all social media platforms.

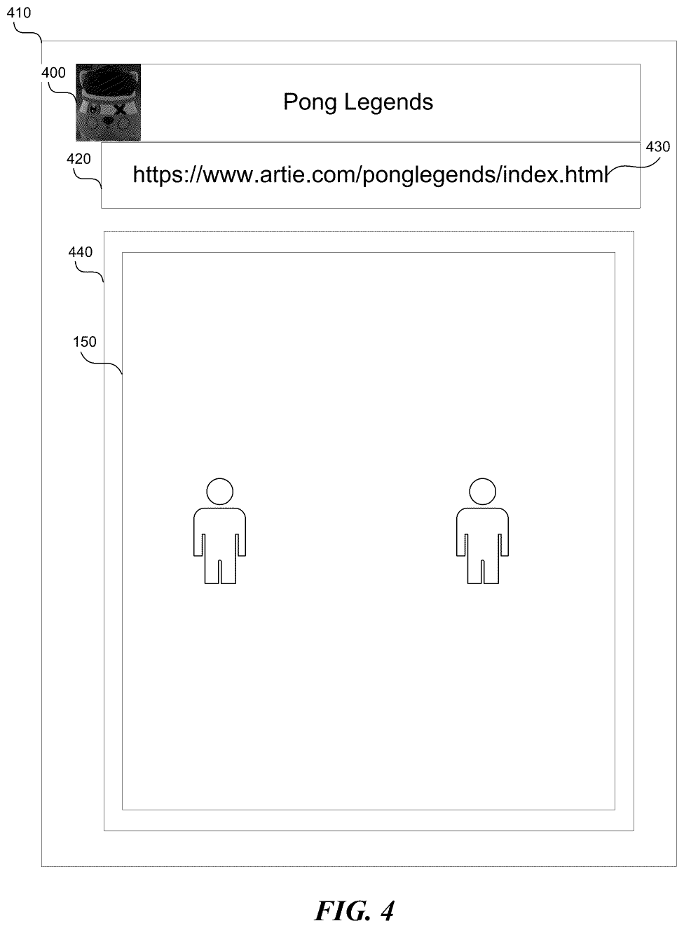

FIG. 4 shows how a link to the game can be presented to the user. The game 150 can have a social media identity 400 that can post updates on various social media platforms 410 such as TikTok, Facebook, Twitter, YouTube, Instagram, etc. The updates can include news about the game 150, release updates, tips on how to play the game, details about the appearance of a special feature in the game, etc. The social media identity 400 representing the game 150 can have followers. In addition, the social media identity 400 can create posts 420 including a link 430 to the game 150. The social media identity 400 can determine which posts 420 are popular, e.g. based on the number of views and/or likes, and can try to generate similar content in the future. The social media identity 400 can interact with other users of the social media platform through posting, commenting, following at least a portion of the other users, receiving comments from at least a portion of the other users, and garnering followers on the social media platform as a human user can. For example, the social media identity's 400 posts 420 can be re-shared with others, and the social media identity 400 can re-share other users' posts.

The user can follow the social media identity 400 on the social media platform 410. The user can select the link 430 to the game 150, and instead of being redirected to the app store 130 as in FIG. 1, the system can present an embedded browser 440 through which the user can play the game 150. In this scenario, the user can make a single-click selection of the link 430 and instantly start to play the game 150, as opposed to having to perform 3 steps, interact with 3 different applications, download an application, and wait several minutes for the installation.

The embedded browser 440 runs within the social media platform 410, and enables the user to stay within the social media platform 410. The user can easily indicate to the game to go back to the social media platform 410, such as with the swipe gesture. Once the user exits the game, the user is presented with the user interface of the social media platform 410.

The game 150 can be a multiplayer game. Different users from different social media platforms 410 can join the same game 150 and play with each other at the same time.

The server 310 in FIG. 3 can gather information about the user interactions with the game. For example, the server 310 can determine a time period, such as between 8 p.m. and 9 p.m., when the user interacts with the game 150, and the social media identity 400 can post the link 430 to be visible to the user during that time period. In addition, the server 310 can model not only individual behavior, but group behaviors as well.

The server 310 can separate the users into groups based on the social media platform 410 viewed by the users, and can provide posts based on the social media platform. For example, the server 310 can determine that the Instagram users play the game 150 between noon and 1 p.m., while the TikTok users play the game 150 between 1 p.m. and 5 p.m. Consequently, the social media identity 400 can post the link 430 to Instagram between noon and 1 p.m., and post the link to TikTok between 1 p.m. and 5 p.m. Each link posted by the social media identity 400 can include a code identifying the social media platform 410 in which the user is viewing the post and selecting the link. The server 310 can receive the code, and can group the users based on the code.

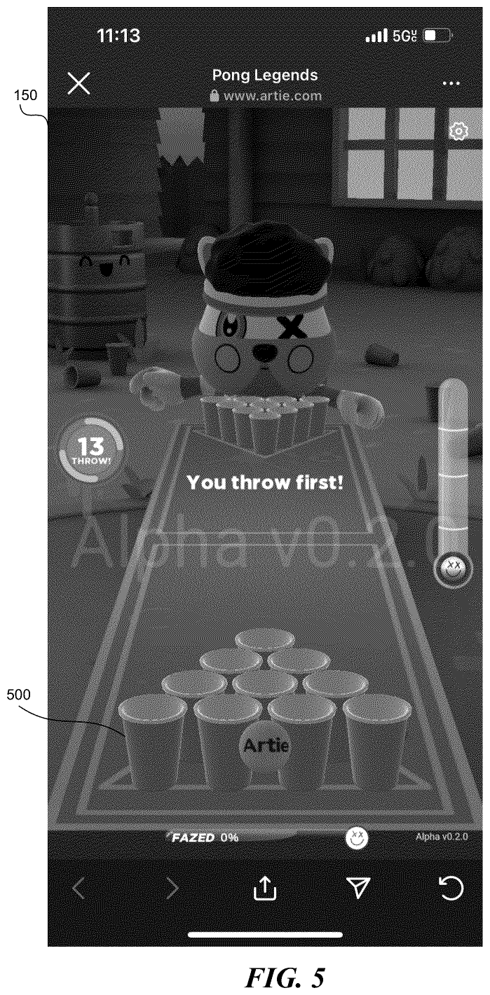

FIG. 5 shows a frame from the game 150. The game 150 enables users to play virtual beer pong with each other. The number of cups 500 determines the length of the game. As explained in this application, the server 310 can gather user data, such as how much time the user and/or a group of users spends in the game 150. If the server 310 in FIG. 3 determines that user A spends 3 minutes but user B spends 10 minutes playing the game, the server 310 can adjust the game to last the appropriate amount of time. For example, for user A, the system can present the game 150 with 2 opponents having 4 cups each, while for user B, the system can present the game 150 with 2 opponents having 9 cups each.

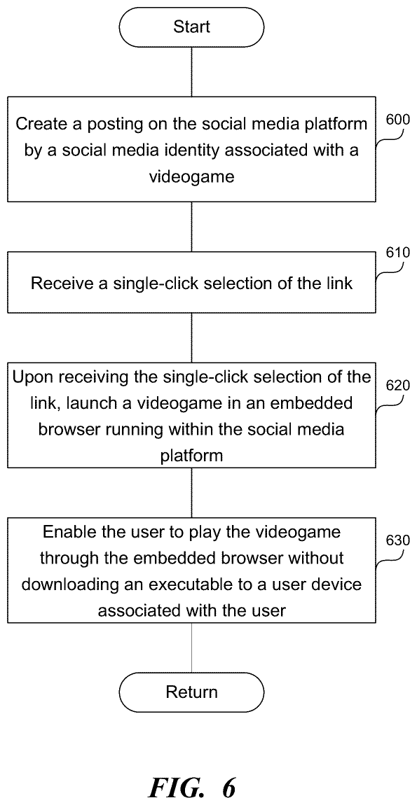

FIG. 6 is a flowchart of a method to enable a user to play a videogame via a single-click selection of a link presented in a social media platform. In step 600, a hardware or software processor performing instructions described in this application can create a first posting on the first social media platform by a first social media identity associated with a multiplayer videogame (“videogame” or “game”), where the first posting includes a first link to the multiplayer videogame. Additionally, the processor can create a second posting on the second social media platform by a second social media identity associated with the multiplayer videogame, where the second posting includes a second link to the multiplayer videogame.

In step 610, the processor can receive a single-click selection of the first link and a single-click selection of the second link, where the single-click selection of the first link is received through the first social media platform and the single-click selection of the second link is received through the second social media platform.

In step 620, upon receiving the single-click selection of the first link, the processor can launch a multiplayer videogame in a first embedded browser running within the first social media platform, where a first user making the single-click selection of the first link remains within the first social media platform while interacting with the first embedded browser. Upon receiving the single-click selection of the second link, the processor can launch a multiplayer videogame in a second embedded browser running within the second social media platform, where a second user making the single-click selection of the second link remains within the second social media platform while interacting with the second embedded browser.

In step 630, the processor can enable the first user and the second user to play the multiplayer videogame together through the first and the second embedded browser without downloading an executable to a first user device associated with the first user and a second user device associated with the second user. The processor can receive an indication to exit from the multiplayer videogame. Upon exiting from the multiplayer videogame, the processor can present a user interface of the first social media platform to the first and the second user.

The processor can create an NFT representing an asset associated with the videogame. The asset can include a prop, a character, a reward received in the videogame or a purchased item, a character attribute such as a skill, etc. The processor can enable access to the NFT from the videogame and a third-party software including the social media platform. The processor can receive an indication to modify at least a portion of the asset, and as a result can modify the asset. The processor can propagate the modification of the assets to the videogame and the third-party software including the social media platform.

The processor can obtain data associated with the first user from an interaction between the first user and the first embedded browser, where the data includes an average time period that the first user engages with the multiplayer videogame. The processor can adjust the videogame to last within the average time period. For example, if the user plays the game for 2 to 3 minutes, the processor can reduce the number of cups in FIG. 5 so that the user game lasts 2 to 3 minutes. The processor can group users based on the platform, and the processor can adjust the game based on the platform, not just the user.

The processor can determine assets associated with the multiplayer videogame to download to the first user device. The processor can determine a chronological order of assets needed by the first user device. The processor can provide the assets to the first user device based on the chronological order. For example, the processor can create a queue in chronological order of the assets that are needed next, and provide assets to the device in the order in which they are needed.

The processor can obtain data associated with the first user from an interaction between the first user and the first embedded browser, where the data includes a time period, such as from 11 p.m. to midnight on weekdays and 10 p.m. to midnight on weekends, when the first user tends to be active on the first social media platform. During the time period, e.g., from 11 p.m. to midnight on weekdays and 10 p.m. to midnight on weekends, the processor can present the first posting.

The processor can determine network bandwidth between a server executing the multiplayer videogame and the first user device or a computational capability associated with the first user device. The processor can adjust appearance associated with the game based on the network bandwidth or the computational capability.

The processor can obtain data associated with the first user from an interaction between the first user and the first embedded browser. Based on the data associated with the first user, the processor can adjust an attribute associated with the game.

To create the posting on the social media platform, the processor can obtain an advertisement. The processor can modify the advertisement to include a play button configured to launch the multiplayer videogame in the embedded browser. The processor can create the posting including the modified advertisement.

### Computer System

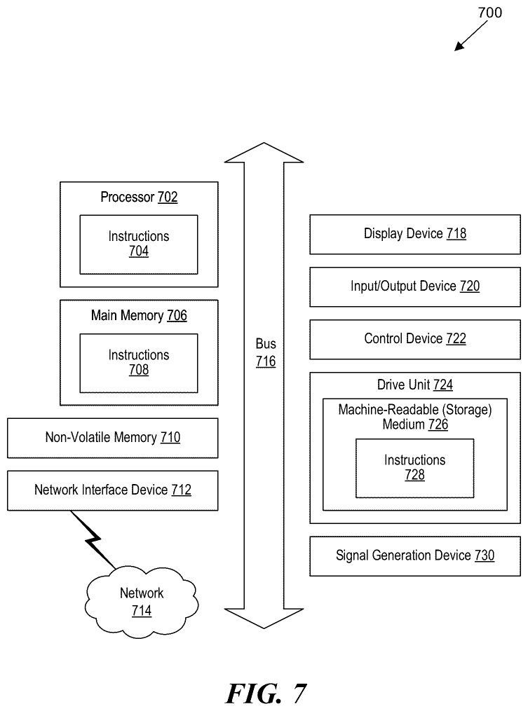

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 700. In some implementations, the computer system 700 can be an embedded computer system, a system-on-chip (SOC), a single-board computer system (SBC), or a distributed system such as a mesh of computer systems, or can include one or more cloud components in one or more networks. Where appropriate, one or more computer systems 700 can perform operations in real time, in near real time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Remarks

The terms “example,”“embodiment,” and “implementation” are used interchangeably. For example, references to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,”“comprising,” and the like are to be construed in an inclusive sense, as opposed to an exclusive or exhaustive sense; that is to say, in the sense of “including, but not limited to.” As used herein, the terms “connected,”“coupled,” and any variants thereof mean any connection or coupling, either direct or indirect, between two or more elements; the coupling or connection between the elements can be physical, logical, or a combination thereof. Additionally, the words “herein,”“above,”“below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. At least one non-transitory computer-readable storage medium storing instructions to enable a first user to play a multiplayer videogame via a single-click selection of a link presented in a first social media platform, which, when executed by at least one data processor of a system, cause the system to:
create a first posting on the first social media platform by a first social media identity associated with the multiplayer videogame,
wherein the first posting includes a first link to the multiplayer videogame;
create a second posting on a second social media platform by a second social media identity associated with the multiplayer videogame,
wherein the second posting includes a second link to the multiplayer videogame;
receive a single-click selection of the first link and a single-click selection of the second link,
wherein the single-click selection of the first link is received through the first social media platform and the single-click selection of the second link is received through the second social media platform;
upon receiving the single-click selection of the first link, launch the multiplayer videogame in a first embedded browser running within the first social media platform,
wherein the first user making the single-click selection of the first link remains within the first social media platform while interacting with the first embedded browser;
upon receiving the single-click selection of the second link, launch the multiplayer videogame in a second embedded browser running within the second social media platform,
wherein a second user making the single-click selection of the second link remains within the second social media platform while interacting with the second embedded browser; and
enable the first user and the second user to play the multiplayer videogame together through the first and the second embedded browser without downloading an executable to a first user device associated with the first user and a second user device associated with the second user.

2. The at least one non-transitory computer-readable storage medium of claim 1, comprising instructions to:
create a non-fungible token representing an asset associated with the multiplayer videogame;
enable access to the non-fungible token from the multiplayer videogame and a third-party software including the first and the second social media platform;
receive an indication to modify at least a portion of the asset;
modify at least the portion of the asset; and
propagate the modification of at least the portion of the asset to the multiplayer videogame and the third-party software including the first and the second social media platform.

3. The at least one non-transitory computer-readable storage medium of claim 1, comprising instructions to:
obtain data associated with the first user from an interaction between the first user and the first embedded browser,
wherein the data includes an average time period that the first user engages with the multiplayer videogame; and
adjust the multiplayer videogame to last within the average time period.

4. The at least one non-transitory computer-readable storage medium of claim 1, comprising instructions to:
determine assets associated with the multiplayer videogame to download to the first user device;
determine a chronological order of assets needed by the first user device; and
provide the assets to the first user device based on the chronological order.

5. The at least one non-transitory computer-readable storage medium of claim 1, comprising instructions to:
obtain data associated with the first user from an interaction between the first user and the first embedded browser,
wherein the data includes a time period when the first user tends to be active on the first social media platform; and
during the time period, present the first posting.

6. The at least one non-transitory computer-readable storage medium of claim 1, comprising instructions to:
determine network bandwidth between a server executing the multiplayer videogame and the first user device or a computational capability associated with the first user device; and
adjust an appearance associated with the multiplayer videogame based on the network bandwidth or the computational capability.

7. The at least one non-transitory computer-readable storage medium of claim 1, comprising instructions to:
obtain data associated with the first user from an interaction between the first user and the first embedded browser; and
based on the data associated with the first user, adjust an attribute associated with the multiplayer videogame.

8. The at least one non-transitory computer-readable storage medium of claim 1, wherein the instructions to create the first posting on the first social media platform comprise instructions to:
obtain an advertisement;
modify the advertisement to include a play button configured to launch the multiplayer videogame in the first embedded browser; and
create the first posting including the modified advertisement.

9. A method comprising:
creating a posting on a social media platform by a social media identity associated with a videogame,
wherein the posting includes a link to the videogame;
receiving a single-click selection of the link,
wherein the single-click selection is received through the social media platform;
upon receiving the single-click selection of the link, launching a videogame in an embedded browser running within the social media platform,
wherein a user remains within the social media platform while interacting with the embedded browser; and
enabling the user to play the videogame through the embedded browser without downloading an executable to a user device associated with the user.

10. The method of claim 9, comprising:
creating a non-fungible token representing an asset associated with the videogame;
enabling access to the non-fungible token from the videogame and a third-party software including the social media platform;
receiving an indication to modify at least a portion of the asset;
modifying at least the portion of the asset; and
propagating the modification of at least the portion of the asset to the videogame and the third-party software including the social media platform.

11. The method of claim 9, comprising:
obtaining data associated with the user from an interaction between the user and the embedded browser,
wherein the data includes an average time period that the user engages with the videogame; and
adjusting the videogame to last within the average time period.

12. The method of claim 9, comprising:
determining assets associated with the videogame to download to the user device;
determining a chronological order of assets needed by the user device; and
providing the assets to the user device based on the chronological order.

13. The method of claim 9, comprising:
obtaining data associated with the user from an interaction between the user and the embedded browser,
wherein the data includes a time period when the user tends to be active on the social media platform; and
during the time period, presenting the posting.

14. The method of claim 9, comprising:
determining network bandwidth between a server executing the videogame and the user device or a computational capability associated with the user device; and
adjusting appearance associated with the videogame based on the network bandwidth or the computational capability.

15. The method of claim 9, comprising:
obtaining data associated with the user from an interaction between the user and the embedded browser; and
based on the data associated with the user, adjusting an attribute associated with the videogame.

16. The method of claim 9, wherein creating the posting on the social media platform comprises:
obtaining an advertisement;
modifying the advertisement to include a play button configured to launch the videogame in the embedded browser; and
creating the posting including the modified advertisement.

17. A system comprising:
at least one hardware processor; and
at least one non-transitory memory storing instructions, which, when executed by the at least one hardware processor, cause the system to:
create a posting on a social media platform by a social media identity associated with a videogame,
wherein the posting includes a link to the videogame;
receive a single-click selection of the link,
wherein the single-click selection is received through the social media platform;
upon receiving the single-click selection of the link, launch a videogame in an embedded browser running within the social media platform,
wherein a user remains within the social media platform while interacting with the embedded browser; and
enable the user to play the videogame through the embedded browser without downloading an executable to a user device associated with the user.

18. The system of claim 17, comprising instructions to:
create a non-fungible token representing an asset associated with the videogame;
enable access to the non-fungible token from the videogame and a third-party software including the social media platform;
receive an indication to modify at least a portion of the asset;
modify at least the portion of the asset; and
propagate the modification of at least the portion of the asset to the videogame and the third-party software including the social media platform.

19. The system of claim 17, comprising instructions to:
obtain data associated with the user from an interaction between the user and the embedded browser,
wherein the data includes an average time period that the user engages with the videogame; and
adjust the videogame to last within the average time period.

20. The system of claim 17, comprising instructions to:
determine assets associated with the videogame to download to the user device;
determine a chronological order of assets needed by the user device; and
provide the assets to the user device based on the chronological order.

21. The system of claim 17, comprising instructions to:
obtain data associated with the user from an interaction between the user and the embedded browser,
wherein the data includes a time period when the user tends to be active on the social media platform; and
during the time period, present the posting.

22. The system of claim 17, comprising instructions to:
determine network bandwidth between a server executing the videogame and the user device or a computational capability associated with the user device; and
adjust appearance associated with the videogame based on the network bandwidth or the computational capability.

23. The system of claim 17, comprising instructions to:
obtain data associated with the user from an interaction between the user and the embedded browser; and
based on the data associated with the user, adjust an attribute associated with the videogame.

24. The system of claim 17, wherein the instructions to create the posting on the social media platform comprise instructions to:
obtain an advertisement;
modify the advertisement to include a play button configured to launch the videogame in the embedded browser; and
create the posting including the modified advertisement.

25. A system comprising:
at least one hardware processor; and
at least one non-transitory memory storing instructions, which, when executed by the at least one hardware processor, cause the system to:
create a social media identity on a social media platform,
wherein the social media identity is associated with a videogame,
wherein the social media identity is configured to interact with other users of the social media platform through posting, commenting, following at least a portion of the other users, receiving comments from at least a portion of the other users, and garnering followers on the social media platform;
create a posting on the social media platform by the social media identity associated with the videogame,
wherein the posting includes a link to the videogame;
receive a single-click selection of the link,
wherein the single-click selection is received through the social media platform;
upon receiving the single-click selection of the link, launch a videogame in an embedded browser running within the social media platform,
wherein a user remains within the social media platform while interacting with the embedded browser; and
enable the user to play the videogame through the embedded browser without downloading an executable to a user device associated with the user.
